(19) United States
(12) Patent Application Publication
(10) Pub. No.: US 2025/0254704 A1
(43) Pub. Date: Aug. 7, 2025

(54) METHODS OF TRANSMITTING A SIGNAL VIA A SIDELINK CHANNEL IN AN UNLICENSED RADIO BAND OF A RADIO ACCESS NETWORK

(71) Applicant: Robert Bosch GmbH, Stuttgart (DE)

(72) Inventors: Khaled Shawky Hassan, Sarstedt (DE); Maximilian Stark, Hamburg (DE)

(21) Appl. No.: 18/856,899

(22) PCT Filed: Apr. 27, 2022
(86) PCT No.: PCT/EP2022/061152

§ 371 Date: Oct. 15, 2024

(51) Int. Cl. H04W 72/25; H04W 74/0808

(52) U.S. Cl. CPC H04W 72/25; H04W 74/0808

(57) ABSTRACT

A method of transmitting a signal in an unlicensed radio band of a radio access network. The method includes: performing channel sensing of the sidelink channel by decoding sidelink information of the sidelink channel during a sensing period, to identify at least one transmission resource of the sidelink channel for transmitting the signal to the second radio node; Performing channel contention of the sidelink channel using a listen-before-talk mechanism during a contention period preceding the at least one identified transmission resource, wherein the sensing period and the contention period overlap at least partially; based on a positive result of the channel contention, accessing the sidelink channel for the duration of a channel occupancy time comprising the at least one identified transmission resource; and transmitting the signal from a first radio node to a second radio node using the at least one identified transmission resource of the sidelink channel.

### FIELD

The present invention concerns two associated methods of transmitting a signal via a sidelink channel in an unlicensed radio band of a radio access network, and associated radio nodes, a system for radio communication, associated computer program elements, and non-transitory computer readable media.

### BACKGROUND INFORMATION

Connected mobility is the subject of a variety of communication standards such as IEEE 802.11p/bd and 3GPP LTE/NR V2X. Two scenarios are considered for 3GPP LTE/NR V2X-that User Equipment (UE) can be within communication range of a base station (BS) such as an evolved-Node BS (eNB) or a 5G-NR-Node BS (gNB), or out of communication range. Another scenario is that a proportion of the UEs that are connected may be connected to the network, and the remainder of the UEs that are connected may be out of network coverage. This is referred to as partial out of coverage.

Typically, when a UE (for example, UE mounted in a vehicle) is in coverage, the UE can be configured to perform sidelink communication with other UEs in range. In this case, resource allocation, data control, and communication procedures are controlled by the UE. In the case that a UE is out of coverage of, for example, EUTRA or 5G-NR cells, the UE is pre-configured with mandatory configuration for autonomous communication using the sidelink. In example, a UE can be pre-configured with several out-of-coverage frequencies. As an example, the out-of-coverage frequencies may include the Intelligent Transport System (ITS) frequencies. Sidelink communications can operate in licensed or unlicensed radio frequency bands.

In LTE, licensed assisted access for the downlink was initially introduced using “listen-before-talk” (LBT) to avoid collision with existing transmission in the unlicensed bands. Licensed assisted access enhancements (eLAA) introduced LBT on the uplink. 5G new radio (NR) introduces unlicensed operation for both uplink (UL) and downlink (DL) either in licensed coverage or unlicensed coverage. In this case, a radio node such as a UE or gNB starts an LBT channel sensing to discover nearby interference. After winning an LBT, either the gNB or the UE initiate a channel occupancy time (COT). A COT is dependent on many factors, such as the frequency of LBT-false, the number of HARQ NACKS, etc. During the COT, the UE or gNB transmit their UL or DL, simultaneously.

5G NR for unlicensed operation introduces two approaches for channel sharing based on supported traffic needs: a load-based event (LBE) or a frame-based event (FBE) COT. In LBE, either the UE or gNB access the channel after a successful LBT whenever there is data to be transmitted in the uplink or downlink. In this case, the radio node is only able to start an LBT directly before a pre-scheduled UL-grant to be able to occupy its scheduled time slot. In a not very different occupancy and granting procedure, FBE is performing an LBT in a time deterministic manner, however a COT is shared with the other devices to send feedback or return traffic.

The COT sharing between uplink and downlink must guarantee a short time gap between the traffic direction switching between a first device (initiating the COT) and a second device (sharing the same COT) such as not more than 16 μs. After such a time gap, the second device is supposed to share the COT and send feedback or return traffic after a short sensing interval (LBT-CAT2) or no sensing (LBT-CAT1). However, if a short LBT (LBT-CAT2) is mandated, the second device refrains from transmission if the LBT result is negative.

### SUMMARY

According to a first aspect of the present invention, there is provided a method of transmitting a signal from a first radio node to a second radio node via a sidelink channel in an unlicensed radio band of a radio access network.

An example method according to the first aspect comprises:
Performing channel sensing of the sidelink channel by decoding sidelink information of the sidelink channel during a sensing period, in order to identify at least one transmission resource of the sidelink channel for transmitting the signal to the second radio node;
Performing channel contention of the sidelink channel using a listen-before-talk mechanism during a contention period preceding the at least one identified transmission resource, wherein the sensing period and the contention period overlap at least partially;
Based on a positive result of the channel contention, accessing the sidelink channel for the duration of a channel occupancy time comprising the at least one identified transmission resource; and
Transmitting the signal from the first radio node to the second radio node using the at least one identified transmission resource of the sidelink channel.

Channel sensing of the sidelink channel is performed in order to identify one or multiple transmission resources that can be used for transmitting the signal via the sidelink channel. To this end, sidelink information is decoded during the sensing period. The sensing period can be understood as a sensing window of a certain or specified period preceding the sidelink transmission.

Sidelink information used for identifying the at least one transmission resource may comprise sidelink control information (SCI) or additional sidelink assisting information, e.g., sidelink reference signal information or sidelink pilot signal information.

For identifying the at least one transmission resource sidelink information may be decoded taking into account a specified selection window, i.e., only transmission resources during the selection window are identified as candidates for transmitting the signal.

Channel contention of the sidelink channel is performed in order to avoid collisions between transmissions of different radio nodes. To this end, a listen-before-talk mechanism is used that may detect ongoing transmissions from other radio nodes. The listen-before-talk mechanism or procedure preferably comprises measuring received energy levels of transmissions from other devices. The channel contention is preferably performed immediately before the transmission identified transmission resource. The identified transmission resource may be a candidate resource selected by the first radio node or a reserved periodic resource.

The result of the channel contention can either be positive (LBT win) or negative (LBT failure). In case a measured energy level of transmissions from other devices is lower than a certain specified threshold (LBT win), the sidelink channel may be accessed by the first radio node for a period called channel occupancy time (COT). The channel occupancy time may start immediately when the channel contention is terminated with a positive result (LBT win).

In case a measured energy level of transmissions from other devices is equal or higher than the certain specified threshold (LBT failure), the sidelink channel may not be accessed by the first radio node. Instead, for accessing the channel and transmitting the signal it is preferably required that the channel contention is performed once again by the first radio node.

According to an example embodiment of the present invention, the contention period of the channel contention is preferably shorter than the sensing period. The contention period starts preferably later than the sensing period. The contention period ends preferably at the same time as or later than the sensing period.

The channel occupancy time may overlap at least partially with the selection window for identifying the transmission resource. The channel occupancy time may extend beyond the selection window.

Transmitting the signal preferably comprises transmitting a physical sidelink control channel for transmitting sidelink control information, followed by transmitting a physical sidelink shared channel for transmitting payload data.

According to a second aspect of the present invention, there is provided a method of transmitting a signal from a second radio node to a first radio and/or a third radio node via a sidelink channel in an unlicensed radio band of a radio access network.

An example method according to the second aspect comprises:
Receiving a signal transmitted from the first radio node to the second radio node via the sidelink channel in the unlicensed radio band during a channel occupancy time of the first radio node, wherein the received signal comprises information regarding the channel occupancy time of the first radio node;
Accessing the sidelink channel during the channel occupancy time of the first radio node; and
Transmitting the signal from the second radio node to the first radio node and/or the third radio node via the sidelink channel, wherein the signal is transmitted by sharing the channel occupancy time of the first radio node.

Sharing the channel occupancy time of the first radio node may be understood as accessing the channel and transmitting a signal by the second radio node during the channel occupancy time of the first radio node, in particular without performing channel contention of 3GPP category 4. Sharing the channel occupancy time means that once the first radio node initiates the channel occupancy time and transmits at least one signal, the second radio node may transmit a signal in response to the received signal from the first radio node, without performing channel contention by using a listen-before-talk mechanism of 3GPP category 4.

According to a third aspect of the present invention, there is provided a first radio node. According to an example embodiment of the present invention, the first radio node comprises a radio modem, non-transitory computer readable media comprising machine readable instructions, and a processor configured to load and to execute the machine readable instructions to cause the first radio node to execute the method according to the first aspect, or its embodiments, and thus to transmit a signal from the first radio node to a second radio node via a sidelink channel in an unlicensed radio band of a radio access network.

According to a fourth aspect of the present invention, there is provided a second radio node. According to an example embodiment of the present invention, the second radio node comprises a radio modem, non-transitory computer readable media comprising machine readable instructions, and a processor configured to load and to execute the machine readable instructions to cause the second radio node to execute the method according to the second aspect, or its embodiments, and thus to transmit a signal from the second radio node to a first radio and/or a third radio node via a sidelink channel in an unlicensed radio band of a radio access network.

According to a fifth aspect of the present invention, there is provided a system for radio communication, comprising a first radio node as defined by the third aspect, and a second radio node as defined by the fourth aspect.

According to a sixth aspect of the present invention, there is provided a computer program element comprising machine readable instructions which, when loaded and executed by a processor, cause the processor to perform the method according to the first aspect and/or the method according to the second aspect.

According to a seventh aspect of the present invention, there is provided a non-transitory computer readable medium comprising the machine readable instructions of the sixth aspect.

The introduced methods of transmitting a signal via a sidelink channel in an unlicensed radio band of a radio access network according to the present invention allow for coexistence of different radio access technologies in an unlicensed radio band. The methods allow to reduce intra-system collision between transmissions of different radio nodes by avoiding interference. Further, the methods are beneficial due to improving the efficiency of using transmission resources and reducing response times in sidelink communications. Transmitting the signal from the second radio node to the first and/or third radio node by sharing the channel occupancy time of the first radio node allows to reduce extra delay introduced by performing channel contention and to improve the efficiency of the sidelink channel usage.

This enables the many regulatory requirements required to access the unlicensed spectrum to be preserved (such as a nominal bandwidth, and contiguous nominal carrier aggregation by the same device). The technique detailed herein is flexible and can be applied to different nominal bandwidths and different nominal aggregate bands as specified between different regions. For example, the ETSI BRAN regulations mandate a nominal frequency of 20 MHz and 4, 8, 16 etc. aggregated bands in the 5 GHz and 6 GHz frequency bands, although the technique discussed herein may be generalized to other regions.

In other words, the first problem addressed is that sidelink communication is limited to dedicated (ITS) and licensed bands. In this case, unlicensed bands can be used to complement the ITS/licensed bands.

The second problem addressed is that it has not been specified how to perform sidelink operation with all communication cast types for unlicensed carriers. In this case, unlicensed FBE can be used.

The third problem addressed is that of initiating a channel occupancy time (COT) and sharing a channel occupancy time (COT). According to this specification, if a sidelink transmission is scheduled, a radio node shares its channel occupancy time for sending sidelink transmissions with other radio nodes, where the other radio nodes use the transmission opportunity with a short time gap so as not to lose the channel contention. The short time gap is a switch symbol at the end of each sidelink slot. If the channel contention by the first radio node fails, a second radio node will not detect the first radio node's sidelink control information and perform CAT-4 LBT.

The present invention therefore provides a technique to access unlicensed frequency bands for sidelink communications. The scheme is focusing on a dedicated unlicensed carrier assisted access, which may mandate the ISM bands regulation for fair sharing among multiple technologies, e.g., 3GPP and WiFi. The dedicated carrier is also used to send broadcast, groupcast and/or unicast information; it can also be used to guarantee synchronization among other wireless nodes.

According to an example embodiment of the first aspect, performing channel sensing comprises
performing first channel sensing of the sidelink channel by decoding sidelink information of the sidelink channel during a first sensing period and
performing second channel sensing of the sidelink channel by decoding sidelink information of the sidelink channel during a second sensing period, wherein the second sensing period and the contention period overlap at least partially. Preferably, the first sensing period precedes the contention period. In particular, the first sensing period and the contention period may not overlap.

In other words, the sensing period may consist of a first sensing period/window and a second sensing period/window. The first sensing period preferably precedes the second sensing period. The first sensing period and the second sensing window may be adjacent or non-adjacent in time. The first sensing period is preferably longer than the second sensing period. The first sensing period allows for decoding possible resource reservations of other radio nodes and identifying possible resource candidates for the transmission of the signal within the selection window. The second sensing period allows for decoding possible recent resource reservations of other radio nodes not detected during the first sensing period.

According to an example embodiment of the first aspect, transmitting the signal comprises transmitting information regarding the channel occupancy time, i.e., the channel occupancy time of the first radio node. The information may comprise the channel occupancy time, a length of the channel occupancy time, an end of the channel occupancy time, and/or how to share the channel occupancy time with other radio nodes.

The information regarding the channel occupancy time may be transmitted explicitly or implicitly to the second and/or a third radio node. An implicit transmission may comprise an index, indicator and/or a specific choice of a transmission format, based on which the information regarding the channel occupancy time may be derived or encoded.

Transmitting information regarding the channel occupancy time allows the second and/or third radio node to share the channel occupancy time of the first radio node.

According to an example embodiment of the first aspect of the present invention, the method according to the first aspect comprises:

Receiving a signal transmitted from the second radio node to the first radio node in the unlicensed band of the radio access network,
wherein the received signal is transmitted by the second radio node by sharing the channel occupancy time of the first radio node.

Sharing the channel occupancy time of the first radio node allows to reduce extra delay introduced when performing channel contention and to improve the efficiency of the sidelink channel usage.

According to an example embodiment of the first aspect of the present invention, the method according to the first aspect comprises:

Responding to the received signal by transmitting a further signal to the second radio node and/or the third radio node in the unlicensed band of the radio access network,
wherein the further signal is transmitted during the channel occupancy time of the first radio node.

The further signal may be transmitted using one of or the last transmission resource of the channel occupancy time of the first radio node.

According to an example embodiment of the first aspect of the present invention, a category of the listen-before-talk mechanism used for performing channel contention is one of the following 3GPP categories: category 4, category 2, category 1. Here, a listen-before-talk mechanism of category 1 can be understood as using no listen-before-talk mechanism. Other suited conventional listen-before-talk mechanisms may be used as an alternative.

For an initial transmission by the first radio node, a listen-before-talk mechanism of category 4 is used preferably. For a further transmission by the first radio node within the channel occupancy time, a list before talk mechanism of category 2 or category 1 may be used by the first radio node. Here, the category of the listen-before-talk mechanism may be selected depending on a gap period between a preceding transmission in the sidelink channel during the channel occupancy time and the transmission of the further signal transmitted by the first radio node. The gap period may be understood as a period during which a measured energy level of transmissions from other devices is a lower than a certain specified threshold.

According to an example embodiment of the first aspect of the present invention and/or an example embodiment of the second aspect of the present invention, the transmission resource used for transmitting the signal by the first radio node and/or a transmission resource used for transmitting the signal by the second radio node is part of an interlace structure of multiple transmission resources of the sidelink channel. The interlace structure may be understood as a structured assignment of the unlicensed radio band to the multiple transmission resources. Here, the unlicensed radio band may be divided or distributed or assigned to the multiple transmission resources such that the multiple transmissions resources are interleaved across a frequency range of the unlicensed radio band. In other words, the interlace structure consists of multiple interleaved interlace patterns, each of them representing a transmission resource.

Each radio node may select a different transmission resource or interlace pattern to transmit a signal in the unlicensed radio band. Transmissions of multiple radio may multiplex themselves on the same unlicensed radio band, thus avoiding collisions between simultaneous transmissions of different radio nodes.

Advantageously, a predetermined portion of the unlicensed radio band comprising the multiple transmission resources may be divided into multiple consecutive subportions, wherein each of the transmission resources comprises at least two non-consecutive subportions of the unlicensed radio band, such that the multiple transmission resources form the interlace structure of the sidelink channel across the predetermined portion of the unlicensed radio band.

The predetermined portion of the unlicensed radio band may comprise the full unlicensed radio band, or only a part, e.g., 80%, of the unlicensed radio band. The subportions may be of equal length in frequency. Subportions comprised by or assigned to the same transmission resource are non-consecutive or non-adjacent in frequency and may further be equidistant in frequency.

By forming the interlace structure of the sidelink channel across the predetermined portion of the unlicensed radio band, each of the multiple transmission resources allows to distribute single transmissions across the frequency range of the predetermined portion

According to a first advantageous alternative of the present invention,
two consecutive subportions represent resource blocks of different sidelink subchannels of the sidelink channel,
each of the sidelink subchannels comprises multiple non-consecutive resource blocks, and
each of the transmission resources comprises all resource blocks belonging to the same sidelink subchannel.

As an example, the predetermined portion of the unlicensed radio band may be divided into N=S*M consecutive subportions, wherein S denotes the number of different subchannels. Here, every S consecutive subportions may represent resource blocks of the S different sidelink subchannels, preferably arranged in the same order across the predetermined portion of the unlicensed radio band. Thus, the subchannels themselves are interleaved across the frequency range of the unlicensed radio band.

According to a second advantageous alternative of the present invention,
each of the subportions represents a different sidelink subchannel of the sidelink channel and
each of the transmission resources comprises at least two non-consecutive sidelink subchannels

In other words, the subchannels consist of a single resource block or comprise only consecutive resource blocks. By combining at least two non-consecutive subchannels to one transmission resource, the multiple transmission resources are interleaved across the frequency range of the unlicensed radio band.

Thus, for transmission via a sidelink channel of an unlicensed radio band, the interlace structure is configured to guarantee operation on the minimum nominal bandwidth.

According to an example embodiment of the first aspect of the present invention and/or an embodiment of the second aspect of the present invention, performing channel contention comprises performing channel contention of multiple subbands of the sidelink channel, wherein a bandwidth part of the sidelink channel is adapted based on the result of the channel contention of the multiple subbands.

According to an example embodiment of the first aspect of the present invention and/or an example embodiment of the second aspect of the present invention, the adapted bandwidth part may comprise subbands of the sidelink channel for which a result of the channel contention is positive. As an example, the channel may comprise multiple subbands, wherein for at least one subband the result of the channel contention is positive and for at least one other subband the result of the channel contention is negative. The adapted bandwidth part preferably comprises only the at least one subband for which the channel contention is positive. In other words, the bandwidth part of the sidelink channel is adapted by eliminating the at least one subband for which the result of the channel contention is negative. The subbands of the adapted bandwidth part may be (non-)consecutive or (non-)adjacent in frequency.

This embodiment addresses the problem of designing bandwidth part (BWP) for wideband operation. In case of unlicensed bands, wideband operation depends on the successful listen-before-talk mechanism in each sub-band. Therefore, BWP design for sidelink Release 16 doesn't perfectly hold. This embodiment provides a flexible bandwidth operation for listen-before-talk based wideband operation.

According to an example embodiment of the second aspect of the present invention, the method further comprises:

Before accessing the sidelink channel, performing channel contention of the sidelink channel using a listen-before-talk mechanism.

Preferably, channel contention is performed by the second radio note after the signal transmitted from the first radio node is received by the second radio node.

Based on a positive result of the channel contention, the sidelink channel may be assessed by the second radio node during the channel occupancy time of the first radio node.

According to an example embodiment of the second aspect of the present invention, a category of the listen-before-talk mechanism used for performing channel contention is one of the following 3GPP categories: category 4, category 2, category 1. Here, a listen-before-talk mechanism of category 1 can be understood as using no listen-before-talk mechanism. Other suited conventional listen-before-talk mechanisms may be used as an alternative.

According to an example embodiment of the second aspect of the present invention, the category of the before talk mechanism is selected depending on a gap period between a preceding transmission during the channel occupancy time and a transmission of the signal transmitted by the second radio node. In other words, both the preceding signal and the signal transmitted by the second radio node are transmitted during the channel occupancy time of the first radio node.

As an example, the sidelink channel may be accessed and shared by the second radio node using a listen-before-talk mechanism of category 1 if there is a gap between the transmission of the first radio node and the transmission of the second radio node of less than 16 microseconds within the channel occupancy time. The sidelink channel may be accessed and shared by the second radio node using a listen-before-talk mechanism of category 2 if there is a gap between the transmission of the first radio node and the transmission of the second radio node of more than 16 microseconds and less than 25 microseconds within the channel occupancy time. If there is a gap between the transmission of the first radio node and the transmission of the second radio node of more than 25 microseconds, the sidelink channel may only be accessed by the second radio node when using a listen-before-talk mechanism of category 4.

According to an example embodiment of the second aspect of the present invention, transmitting the signal comprises transmitting information regarding the channel occupancy time of the first radio node, preferably regarding the remaining channel occupancy time of the first radio node. Here, the signal transmitted by the second radio node by sharing the channel occupancy time of the first radio node may comprise information regarding channel occupancy time of the first radio node.

The information regarding the channel occupancy time may be transmitted explicitly or implicitly to the first and/or a third radio node. An implicit transmission may comprise an index, indicator and/or a specific choice of a transmission format, based on which the information regarding the channel occupancy time may be derived or encoded.

Transmitting information regarding the channel occupancy time allows the further radio nodes to share the channel occupancy time of the first radio node.

According to an example embodiment of the first aspect or the second aspect of the present invention,
the signal is transmitted via at least one of a Physical Sidelink Shared Channel (PSSCH), a Physical Sidelink Control Channel (PSCCH), or a Physical Sidelink Broadcast Channel (PSBCH) and
the information regarding the channel occupancy time is transmitted via a Physical Sidelink Control Channel (PSCCH) or alternative means for transmitting sidelink control information.

Alternative means for transmitting sidelink control information may include variants of sidelink control information or indicators, indices or choices of format representing sidelink control information. Thus, the information regarding the channel occupancy time may be conveyed in a sidelink control information.

According to an example embodiment of the first aspect and/or the second aspect of the present invention, in case at least one of the signals transmitted during the channel occupancy time is transmitted via multiple subbands of the sidelink channel, preferably using wideband operation, at least part of sidelink control information is transmitted in the Physical Sidelink Control Channel (PSCCH), wherein the Physical Sidelink Control Channel (PSCCH) is transmitted in
at least one subband of the sidelink channel, or
all subbands for which the result of channel contention is positive.

The one subband the PSCCH is transmitted in may be the first subband. The part of the sidelink control information may be copied in all subbands, for which the result of channel contention is positive.

According to an example embodiment of the first aspect or the second aspect of the present invention, the first radio node and/or the second radio node operate in either Frame Based Equipment (FBE) mode or Load Based Equipment (LBE) mode.

In LBE mode, the radio node may access the sidelink channel based on a positive result of the channel contention performed whenever there is data to be transmitted by the radio node via the sidelink channel. In FBE mode, channel contention is performed only at synchronized frame boundaries. In case of FBE mode, the transmitted information regarding the channel occupancy time may comprise information about the periodicity of transmissions.

According to an example embodiment of the present invention, the unlicensed radio band may be comprised within at least one of the following ranges: 410-7125 MHz; 24.25-52.6 GHz; 28-60 GHz; >60 GHz.

In particular, the unlicensed radio band may be comprised within at least one of the following ranges: 5150-5925 MHz; 5150-5350 MHz (WAS/RLAN); 5470-5725 MHz (WAS/RLAN); 5725-5855 MHz (FWA); 5855-5875 MHz; 5875-5925 MHz (ITS), 5150-5250 (U-NII-1) 5250-5350 (U-NII-2A) 5350-5470 (U-NII-2B) 5470-5725 (U-NII-2C) 5725-5850 (U-NII-3) or 5850-5925 (U-NII-4).

In particular, the unlicensed radio band may be comprised within at least one of the following ranges: 5925-7125 MHz (e.g., in US) or 5925-6425 MHz (e.g., in EU).

According to an example embodiment of the present invention, at least the first and second radio nodes are members of a 5G NR radio network. The first and/or second radio node may be a user equipment. The first and/or second radio node may comprise an input interface configured to obtain input data, for example commands from a higher layer to perform sidelink communication. The first and/or second radio node may comprise a power supply and/or an antenna coupled to the radio modem of the respective radio node. The first and/or second radio node may support device to device, internet of things, and/or V2X communications.

### BRIEF DESCRIPTION OF THE DRAWINGS

Exemplary embodiments of the present invention are depicted in the figures, which are not to be construed as limiting the present invention, and are explained in greater detail below.

FIGS. 1A, 1B, and 1C schematically illustrate three possible options of the listen-before-talk mechanism.

FIG. 2 schematically illustrates an example of sharing channel occupancy time between two radio nodes operating in frame based equipment mode.

FIG. 3 schematically illustrates another example of sharing channel occupancy time between two radio nodes.

FIGS. 4A and 4B schematically illustrate two alternative interlace structures of multiple transmission resources of a sidelink channel;

FIGS. 5A, 5B, 5C, and 5D schematically illustrate different bandwidth part options for wideband operations

FIG. 6 schematically illustrates an example of a signalling protocol for sharing a channel occupancy time on an unlicensed radio band/

FIGS. 7A and 7B schematically illustrate methods according to the first and the second aspect.

### DETAILED DESCRIPTION OF EXAMPLE EMBODIMENTS

The present invention provides a stand-alone, self-organized channel access for sidelink transmission on an unlicensed carrier. The unlicensed carrier can be used for sidelink communication (sending data, control, and feedbacks).

In this case, stations can also synchronize on carrier 2 if they send broadcast and synchronization information. The synchronization procedure can have all possible option of 3GPP synchronizations, e.g., sync to a synch-master/GNSS, sync to a gNB (broadcasting sync signal in either licensed or unlicensed bands), sync a synch-source UE, etc.

Regarding resource allocation, if a gNB exists, the configuration and control signaling can be conveyed via a Uu carrier, e.g., for mode 1 resource allocation scheme wherein the Uu carrier is a network operating carrier. However, if only unlicensed band is available and no other sync source(s), synchronization between UEs can be conducted via configuring resource pool in mode 2 (but in the unlicensed bands) and exchange of synchronization sequence.

### Sidelink for Load-Based Equipment (LBE) in Unlicensed Band

In this technique, the sidelink communication may be sent in a load-based equipment (LBE) fashion, i.e., send data on demand. This means a UE (or a group of UEs) may perform LBT (simultaneously). The UE (or more UEs) finding the channel to be free wins the LBT. Additionally, the winning UE (or group of UEs) may select resources based on their sensing history of other sidelink transmission and reservation signals. In this case, the UE (or the group of UEs) with winning LBT may allocate 1 out of N interlace pattern in frequency, wherein the interlace pattern may be selected randomly. The selected pattern in time and frequency (following a successful LBT) is used to transmit their control and shared data. Other UEs in the network can either receive control and/or data transmission or try to capture the channel (based on LBT and sidelink transmission window-based sensing) to send their sidelink transmission.

### Sidelink for Frame-Based Equipment (FBE) in Unlicensed Band

Another option would be to allow channel occupancy time (COT) sharing of any urgently needing UE to send their Frame-based equipment (FBE).

The initial procedure: An initial UE (or a group of asynchronous UEs) should sense the channel with an initial LBT (e.g., the longest with CCA, LBT-4) and perform a sliding window-based sensing for sidelink communication.

Based on the successfulness of the LBT (for other radio access technology (RAT)) and a longer window-based sensing (for equivalent sidelink sensing), the initial UE (or a group of asynchronous UEs) should select one of N interlace pattern (randomly) and performs control and data transmission.

Any other station (or a group of stations) which is (are) sensing the network and is (are) able to decode possible control information, which may contain a certain COT duration) may share the COT initially initiated COT by UE1. Another UE (or some “other” UEs) sharing the COT may send its (their) sidelink transmission following an interlace pattern. The other UE (or the other group of UEs) may share the initiated initial COT as far as the COT is sufficient for sending more sidelink transmission.

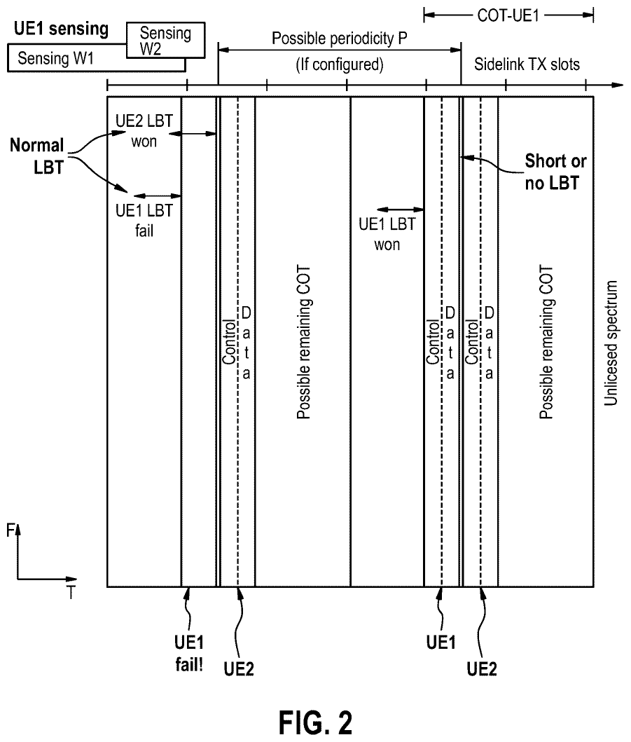

Further, the initial UE 1 (or UE-group 1) may send on the last transmission opportunity of its (their) initiated COT. In case of a FBE, the initiated COT may send some information about the periodicity of sidelink transmission configured grants, i.e., wherein the initial procedure is repeated before each of the declared periods, see FIG. 2.

### Channel Access Using Window-Based Sensing Tailed by LBT

According to an embodiment, a first transmission TRI of a first radio node, e.g., of a first user equipment UE1, needs to be transmitted on an unlicensed carrier which is used for sidelink communication. To this end, UE1 is configured to perform both channel sensing and channel contention. For channel contention, a listen-before-talk mechanism is used.

UE1 is configured to perform sidelink (normal-long or short) channel sensing to extract and decode existing (similar) sidelink transmission from foreign UEs (other UEs). Here, UE1 may be configured to perform sidelink sensing with sidelink control channel decoding, e.g., as in Rel-16 (decode possible sidelink control information (SCI) from other devices with sidelink reservation to select free candidate resources).

Preferably, UE1 is configured to perform a window-based (or sliding window-based) channel sensing with two sensing windows of preferably different sizes, in particular a long sensing window of size W1 and a short sensing window of size W2.

In sidelink communication, a long sensing window may be used to decode all possible reservation of other UEs to select possible candidate resource within a selection window Sw. Additionally, UE1 may start a short sensing window directly before the selected resources. The main role of the short sensing window is to avoid any recent reservation from other UEs not detected during the normal (long) sensing window.

UE1 may be configured accomplish channel contention using a listen-before-talk mechanism to detect existing/competing radio access technologies, e.g., WiFi, within the unlicensed band. The listen-before-talk mechanism is used within or close to the end of the short sensing window, or starting from near the end of the short sensing window.

If the short sensing window is not configured, UE1 shall be requested to perform channel contention using the listen-before-talk mechanism directly before the selected candidate resources (every and all candidate resources or doing the sensing one-by-one, sequentially in time).

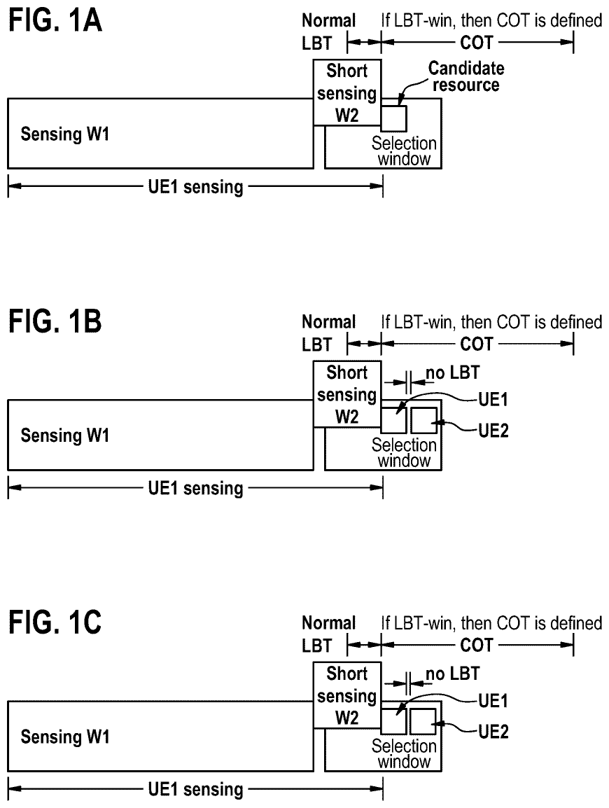

FIG. 1A-1C schematically illustrate three possible options of the listen-before-talk mechanism which may be used for channel contention. In the example of FIG. 1A-1C, channel sensing of the sidelink channel is performed by a first radio node UE1. The sensing period comprises a first sensing window W1 and a second sensing window W2. Here, the first sensing window W1 precedes the second sensing window W2 and is of longer duration than the second sensing window W2. Performing channel sensing allows for identify at least one candidate transmission resource within a selection window for transmitting a signal by the first radio node UE1.

During the second sensing window W2 channel contention using a listen-before-talk mechanism (LBT) is performed. In case the listen-before-talk mechanism is terminated with a positive result (LBT win), UE1 is configured to access the sidelink channel initiating a channel occupancy time (COT).

FIG. 1A illustrates a first option of the listen-before-talk mechanism assuming either LBE (Load-based equipment) or FBE (Frame-based equipment) with a long transmission gap (greater than an allowed short gap, e.g., 16 microseconds). Then, UE1 is configured to perform channel contention by using a long listen-before-talk mechanism, e.g., based on CAT-4 LBT, during (and/or extending) the short sidelink sensing window W2. As an example, UE1 may be configured to use the option according to FIG. 1A before initiating a COT.

FIG. 1B illustrates a second option of the listen-before-talk mechanism assuming FBE with a short transmission gap (between a transmission of UE1 initiating the COT and a following transmission of another UE sharing the COT). Then, UE2 is configured to perform channel contention by using a short listen-before-talk mechanism.

FIG. 1C illustrates a third option of the listen-before-talk mechanism assuming FBE with an extremely short transmission gap (shorter than a predetermined threshold). Then, no listen-before-talk mechanism is performed by UE2, i.e., UE2 is configured to transmit without any LBT mechanism by shared the COT initiated by UE1. The third option also applies to a further transmission of UE1 following a preceding transmission of UE1 within the same COT.

FIG. 2 schematically illustrates an example of sharing channel occupancy time between two radio nodes UE1, UE2 operating in frame based equipment mode.

For a first frame, a channel contention using a listen-before-talk (LBT) mechanism performed by the first radio node UE1 fails (LBT fail). A channel contention using a listen-before-talk (LBT) mechanism performed by the second radio node UE2 is successful (LBT win). Thus, the second radio node UE2 initiates a channel occupancy time (COT) and transmits control data including its COT via a sidelink control channel and further data via a physical sidelink shared channel. The COT of the second radio node UE2 ends without being shared by the first radio node UE1.

For a second frame, a channel contention using a listen-before-talk (LBT) mechanism performed by the first radio node UE1 is successful (LBT win). Thus, the first radio node UE1 initiates a channel occupancy time (COT) and transmits control data including its COT via a sidelink control channel and further data via a physical sidelink shared channel. The COT of the first radio node UE1 is shared by the second radio node UE2, i.e., UE2 is configured to transmit a signal without performing channel contention or only using a short listen-before-talk mechanism, e.g., of 3GPP category 2, within a specified short gap after the transmission of the first radio node UE1.

In other words, UE1 may be configured, to convey information regarding the initiated COT (e.g., starting and duration of the COT) in its control information. As mentioned above, the LBT mechanism is performed before a one or more possible selected candidate resources or before a one or more possible reserved periodic resources. The LBT mechanism may also be performed on candidate resources (one-by-one) in sequence (i.e., near in time has LBT first).

According to an embodiment, channel access by a first radio node UE1 may be shared with a second or further radio nodes (“groupcast”). To this end, the first radio node UE1 initiates a channel occupancy time (COT), transmits a signal, and shares its COT with the other UE(s) preferably in a dedicated sidelink control field. Accordingly, each other UE who may share the initial COT by UE1 (e.g., in a group communication) may have its individual UE's control and data sent after a short- or no-LBT within the COT of the first radio node UE1.

Therefore, the control information of the initiating transmission of the first radio node UE1 may convey the COT information to all other UEs in the network (including the one in a group). Thereafter, for each group member sharing this said COT, the respective transmitted control information may convey the remaining COT to other group members. For the remaining COT initiated by first radio node UE1, another UE (e.g., the second radio node UE2) or other UEs may share the COT in organized fashion. For organizing the transmission of other UEs sharing the remaining COT, the following may apply:
The coordination of the transmission of the UEs, sharing the COT with the first radio node UE1, may be conducted via the first radio node UE1, e.g., at least for answering the message of the first radio node UE1.
The coordination of the transmission of the UEs, sharing the COT with the first radio node UE1, may be conducted via the first radio node UE1, e.g., at least for group cast communication.
The coordination of the transmission of the UEs, sharing the COT with the first radio node UE1, may be conducted via the first radio node UE1, e.g., at least for acknowledging the message of the first radio node UE1 with either ACK or NACK.

For the remaining COT initiated by first radio node UE1, after the transmission of all UEs sharing the COT, first radio node UE1 may answer the other UEs' transmission in the last transmission opportunities in its said initiated COT.

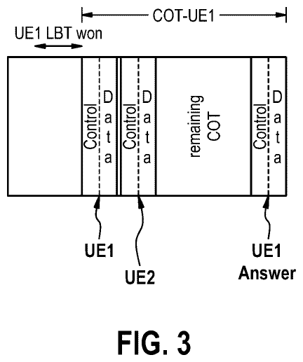

FIG. 3 schematically illustrates another example of sharing channel occupancy time between two radio nodes. Here, after performing, firstly, successful channel sensing (not shown) and, secondly, successful channel contention using a listen-before-talk mechanism, sidelink control information including the COT of the first radio node UE1 and further data is transmitted to at least the second radio node UE2. The COT of the first radio node UE1 is shared by the second radio node UE2. A response signal answering the signal of the second radio node UE2 is transmitted by the first radio node UE1 using the last transmission opportunities within the COT initiated by the first radio node UE1.

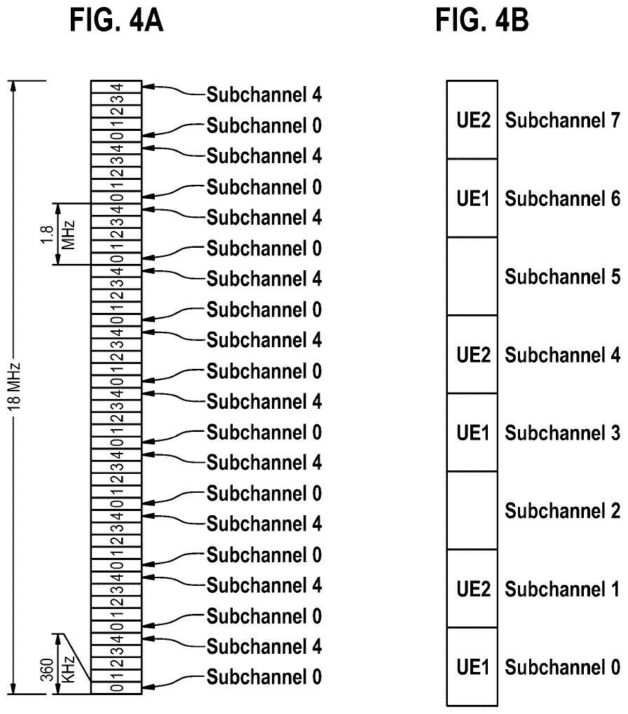

FIGS. 4A and 4B schematically illustrate two alternative interlace structures of multiple transmission resources of a sidelink channel.

Sidelink transmission may follow an interlace structure, wherein the interlace structure should cover at least a predetermined portion, e.g., a certain percentage like 80% of the unlicensed radio band. The sidelink interlace structure for a group of UEs sharing the same slot (e.g., a UE-Group-X is just a set of UEs multiplexing their sidelink transmission over the predetermined portion of the nominal frequency (between 18 and 20 MHz).

If all UEs in the above set (UE-Croup-X) are transmitting their sidelink transmission, the whole band is interleaved with the corresponding sidelink resource blocks. Otherwise, only succeeding UEs (with a winning LBT) in the set UE-group-X can share the sidelink slot band with interlaced frequency structure as illustrated in FIG. 4.

Therefore, in unlicensed access, the sidelink control and data may be interleaved in an interlaced structure to fulfil the required spanning of the bandwidth, wherein only successful LBT or sharing COT UEs are allowed to interlace their sidelink transmission.

FIG. 4A illustrates a resource pool configuration and subchannel design of a first alternative. Here, the resource pool is configured with multiple sidelink subchannels, wherein each single subchannel is not continuous in frequency, but interlaced across the nominal frequency. The interleave width and the length of the subchannels are configurable.

A single radio node may transmit a signal via one of the subchannels. Multiple radio nodes may transmit signals simultaneously by using different subchannels thus multiplexing their sidelink transmissions.

FIG. 4B illustrates a resource pool configuration and subchannel design of a second alternative. Here, the resource pool is configured with multiple adjacent sidelink subchannels, where the subchannels have continuous resources in frequency. The interleave width can be configurable, but the length of the channel may depend on each time allocation.

A single radio node may transmit a signal via one subchannel interlace pattern distributed across the nominal bandwidth, i.e., comprising, e.g., three non-adjacent or non-consecutive subchannels. Multiple radio nodes may transmit signals simultaneously by using different interlace patterns thus multiplexing their sidelink transmissions.

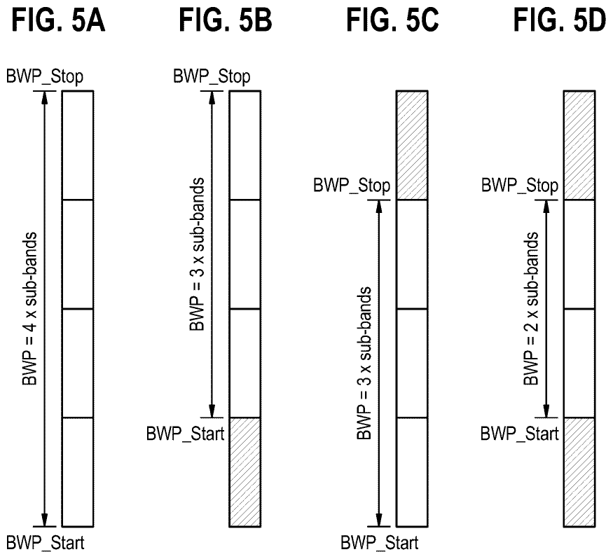

FIG. 5A-5D schematically illustrates different bandwidth part (BWP) options for wideband operations depending on the result of the performed listen-before-talk mechanism for the respective subbands of an unlicensed radio band. The radio band according to FIG. 5A-5D comprises 5 subbands. For each of the subband, channel contention is performed by using a listen-before-talk mechanism.

In unlicensed access, the sidelink BWP is scaled around the LBT subbands for which the result of the LBT mechanism is positive, i.e., the free or idle subbands. In this case, the BWP part is configured to be of maximum width and minimum width. The BWP is scaled to be one or more or all subbands depending on for which of the subbands the results of the LBT mechanism is positive. Preferably, the following applies:

Bandwidth part may start from the first subband for which the result of the LBT mechanism is positive and ends after the last consecutive subband for which the result of the LBT mechanism is positive.

The subchannel transmission should start from the first subband for which the result of the LBT mechanism is positive to the last one for which the result of the LBT mechanism is positive, or vice versa.

The PSCCH should start from the first subchannel in the BWP consuming one or more subchannels (filling up towards the last subchannel) or vice versa (from the last towards the first).

FIG. 5A illustrates a BWP option wherein the result of the LBT mechanism is positive for all subbands. Thus, the bandwidth part starts from the first subband and ends with the fourth subband.

FIG. 5B illustrates a BWP option wherein the result of the LBT mechanism is negative for the first subband and positive for the last three subbands. Thus, the bandwidth part starts from the second subband and ends with the fourth subband.

FIG. 5C illustrates a BWP option wherein the result of the LBT mechanism is positive for the first three subbands and negative for the fourth subband. Thus, the bandwidth part starts from the first subband and ends with the third subband.

FIG. 5D illustrates a BWP option wherein the result of the LBT mechanism is negative for the first and the fourth subband and positive for the second and the third subband. Thus, the bandwidth part starts from the second subband and ends with the third subband.

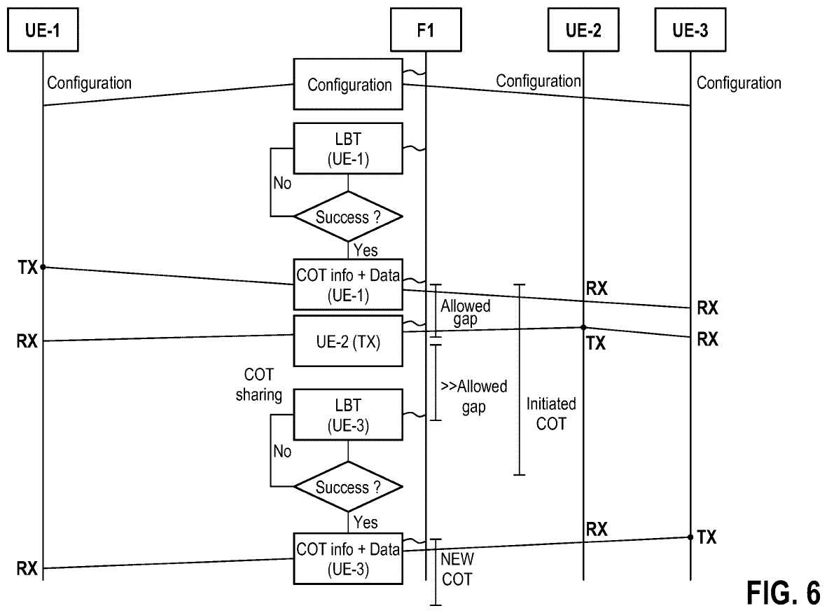

FIG. 6 schematically illustrates an example of a signalling protocol for sharing a channel occupancy time on an unlicensed radio band.

In the example of FIG. 6, a first radio node UE1, a second radio node UE2, and a third radio node UE3 communicate via a sidelink channel in an unlicensed radio band F1 of a radio access network. Initially, a resource pool in the unlicensed band F1 is configured either via a pre-configuration received from a UE or a gNB, or previously stored configuration.

The first radio node UE1 forms channel contention using a listen-before-talk mechanism (LBT) and, if successful, transmits a short control to configure subsequent signalling, and a first signal to at least the second radio node UE2 and optionally the third radio node UE3 (the third radio node UE3 may passively receive all signals transmitted by the first radio node UE2). The first signal comprises information regarding the channel occupancy time (COT) of the first radio node UE1 and additional data.

The second radio node UE2 transmits its signal within an allowed gap without performing channel contention, thus sharing the channel occupancy time of the first radio node UE1. The first radio node UE1 and optionally the third radio node UE3 receive the signal transmitted by the second radio node UE2.

If an amount of time greater than the allowed gap elapses, then a third radio node UE3 must perform a new channel contention operation to access the unlicensed band. Upon completion of the channel contention, the third radio node UE3 transmits a short control to configure subsequent signalling, and a further signal to at least the second radio node UE2 and optionally the first radio node UE3.

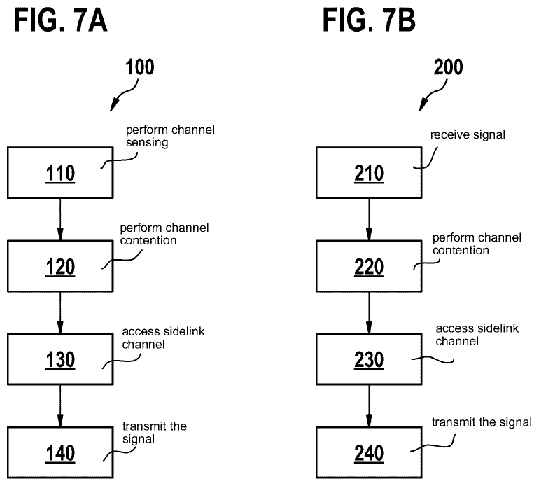

FIG. 7A schematically illustrates a method according to the first aspect. According to a first aspect, there is provided a method 100 of transmitting a signal from a first radio node to a second radio node via a sidelink channel in an unlicensed radio band of a radio access network.

The method 100 according to the first aspect comprises:
Performing 110 channel sensing of the sidelink channel by decoding sidelink information of the sidelink channel during a sensing period, in order to identify at least one transmission resource of the sidelink channel for transmitting the signal to the second radio node;
Performing 120 channel contention of the sidelink channel using a listen-before-talk mechanism during a contention period preceding the at least one identified transmission resource, wherein the sensing period and the contention period overlap at least partially;
Based on a positive result of the channel contention, accessing 130 the sidelink channel for the duration of a channel occupancy time comprising the at least one identified transmission resource; and
Transmitting 140 the signal from the first radio node to the second radio node using the at least one identified transmission resource of the sidelink channel.

FIG. 7B schematically illustrates a method according to the second aspect. According to a second aspect, there is provided a method 200 of transmitting a signal from a second radio node to a first radio and/or a third radio node via a sidelink channel in an unlicensed radio band of a radio access network.

The method 200 according to the second aspect comprises:
Receiving 210 a signal transmitted from the first radio node to the second radio node via the sidelink channel in the unlicensed radio band during a channel occupancy time of the first radio node, wherein the received signal comprises information regarding the channel occupancy time of the first radio node;
Optionally, performing 220 channel contention of the sidelink channel using a listen-before-talk mechanism, and, based on a positive result of the channel contention:
Accessing 230 the sidelink channel during the channel occupancy time of the first radio node; and
Transmitting 240 the signal from the second radio node to the first radio node and/or the third radio node via the sidelink channel, wherein the signal is transmitted by sharing the channel occupancy time of the first radio node.

The examples provided in the drawings and described in the foregoing written description are intended for providing an understanding of the principles of this specification. No limitation to the scope of the present invention is intended thereby. The present specification describes alterations and modifications to the illustrated examples. Only the preferred examples have been presented, and all changes, modifications, and further applications to these within the scope of the specification are desired to be protected.

1-31. (canceled)

32. A method of transmitting a signal from a first radio node to a second radio node via a sidelink channel in an unlicensed radio band of a radio access network, the method comprising the following steps:
performing channel sensing of the sidelink channel by decoding sidelink information of the sidelink channel during a sensing period, to identify at least one transmission resource of the sidelink channel for transmitting the signal to the second radio node;
performing channel contention of the sidelink channel using a listen-before-talk mechanism during a contention period preceding the at least one identified transmission resource, wherein the sensing period and the contention period overlap at least partially;
based on a positive result of the channel contention, accessing the sidelink channel for a duration of a channel occupancy time including the at least one identified transmission resource; and
transmitting the signal from the first radio node to the second radio node using the at least one identified transmission resource of the sidelink channel.

33. The method according to claim 32, wherein the performing of the channel sensing includes
performing first channel sensing of the sidelink channel by decoding sidelink information of the sidelink channel during a first sensing period; and
performing second channel sensing of the sidelink channel by decoding sidelink information of the sidelink channel during a second sensing period, wherein the second sensing period and the contention period overlap at least partially.

34. The method according to claim 32, wherein the transmitting of the signal includes transmitting information regarding the channel occupancy time.

35. The method according to claim 32, further comprising:
receiving a signal transmitted from the second radio node to the first radio node in the unlicensed band of the radio access network;
wherein the received signal is transmitted by the second radio node by sharing the channel occupancy time of the first radio node.

36. The method according to claim 35, further comprising:
responding to the received signal by transmitting a further signal to the second radio node and/or a third radio node in the unlicensed band of the radio access network;
wherein the further signal is transmitted during the channel occupancy time of the first radio node.

37. The method according to claim 32, wherein a category of the listen-before-talk mechanism used for performing the channel contention is one of the following 3GPP categories: category 4, category 2, category 1.

38. The method according to claim 32, wherein the transmission resource used for transmitting the signal is part of an interlace structure of multiple transmission resources of the sidelink channel.

39. The method according to claim 38, wherein:
a predetermined portion of the unlicensed radio band including the multiple transmission resources is divided into multiple consecutive subportions, and
each of the transmission resources includes at least two non-consecutive subportions of the unlicensed radio band, such that the multiple transmission resources form the interlace structure of the sidelink channel across the predetermined portion of the unlicensed radio band.

40. The method according to claim 39, wherein
two consecutive subportions represent resource blocks of different sidelink subchannels of the sidelink channel;
each of the sidelink subchannels includes multiple non-consecutive resource blocks; and
each of the transmission resources includes all resource blocks belonging to the same sidelink subchannel.

41. The method according to claim 39, wherein:
each of the subportions represents a different sidelink subchannel of the sidelink channel; and
each of the transmission resources comprises at least two non-consecutive sidelink subchannels.

42. The method according to claim 32, wherein:
performing the channel contention includes performing channel contention of multiple subbands of the sidelink channel; and
a bandwidth part of the sidelink channel is adapted based on a result of the channel contention of the multiple subbands.

43. The method according to claim 42, wherein the adapted bandwidth part includes subbands of the sidelink channel for which a result of the channel contention is positive.

44. A method of transmitting a signal from a second radio node to a first radio and/or a third radio node via a sidelink channel in an unlicensed radio band of a radio access network, the method comprising the following steps:
receiving a signal transmitted from the first radio node to the second radio node via the sidelink channel in the unlicensed radio band during a channel occupancy time of the first radio node, wherein the received signal includes information regarding the channel occupancy time of the first radio node;
accessing the sidelink channel during the channel occupancy time of the first radio node; and
transmitting the signal from the second radio node to the first radio node and/or the third radio node via the sidelink channel;
wherein the signal is transmitted by sharing the channel occupancy time of the first radio node.

45. The method according to claim 44, further comprising:
before accessing the sidelink channel, performing channel contention of the sidelink channel using a listen-before-talk mechanism.

46. The method according to claim 45, wherein a category of the listen-before-talk mechanism used for performing channel contention is one of the following 3GPP categories: category 4, category 2, category 1.

47. The method according to claim 46, wherein the category of the listen-before-talk mechanism is selected depending on a gap period between a preceding transmission during the channel occupancy time and a transmission of the signal transmitted by the second radio node.

48. The method according to claim 44, wherein the transmitting of the signal includes transmitting information regarding the channel occupancy time of the first radio node, regarding remaining channel occupancy time of the first radio node.

49. The method according to claim 44, wherein a transmission resource used for transmitting the signal is part of an interlace structure of multiple transmission resources of the sidelink channel.

50. The method according to claim 49, wherein:
a predetermined portion of the unlicensed radio band including the multiple transmission resources is divided into multiple consecutive subportions; and
each of the transmission resources includes at least two non-consecutive subportions of the unlicensed radio band, such that the multiple transmission resources form the interlace structure of the sidelink channel across the predetermined portion of the unlicensed radio band.

51. The method according to claim 50, wherein:
two consecutive subportions represent resource blocks of different sidelink subchannels of the sidelink channel;
each of the sidelink subchannels comprises multiple non-consecutive resource blocks; and
each of the transmission resources comprises all resource blocks belonging to the same sidelink subchannel.

52. The method according to claim 50, wherein:
each of the subportions represents a different sidelink subchannel of the sidelink channel; and
each of the transmission resources includes at least two non-consecutive sidelink subchannels.

53. The method according to claim 44, wherein:
performing the channel contention includes performing channel contention of multiple subbands of the sidelink channel; and
a bandwidth part of the sidelink channel is adapted based on a result of the channel contention of the multiple subbands.

54. The method according to claim 53, wherein the adapted bandwidth part comprises subbands for which a result of the channel contention is positive.

55. The method according to claim 32, wherein:
the signal is transmitted via at least one of a Physical Sidelink Shared Channel, a Physical Sidelink Control Channel, or a Physical Sidelink Broadcast Channel; and
the information regarding the channel occupancy time is transmitted via a Physical Sidelink Control Channel or an alternative arrangement for transmitting sidelink control information.

56. The method according to claim 55, wherein:
when at least one of the signals transmitted during the channel occupancy time is transmitted via multiple subbands of the sidelink channel using wideband operation, at least part of sidelink control information is transmitted in the Physical Sidelink Control Channel, wherein the Physical Sidelink Control Channel is transmitted in:
at least one subband of the sidelink channel, or
all subbands for which the result of channel contention is positive.

57. The method according to claim 32, wherein the first radio node and/or the second radio node operate in either Frame Based Equipment mode or Load Based Equipment mode.

58. A first radio node, comprising:
a radio modem;
non-transitory computer readable media including machine readable instructions; and
a processor configured to load and to execute the machine readable instructions, the machine readable instructions being transmitting a signal from the first radio node to a second radio node via a sidelink channel in an unlicensed radio band of a radio access network, the machine-readable instructions, when executed by the processor, causing the first radio node to perform the following steps:
performing channel sensing of the sidelink channel by decoding sidelink information of the sidelink channel during a sensing period, to identify at least one transmission resource of the sidelink channel for transmitting the signal to the second radio node,
performing channel contention of the sidelink channel using a listen-before-talk mechanism during a contention period preceding the at least one identified transmission resource, wherein the sensing period and the contention period overlap at least partially,
based on a positive result of the channel contention, accessing the sidelink channel for a duration of a channel occupancy time including the at least one identified transmission resource, and
transmitting the signal from the first radio node to the second radio node using the at least one identified transmission resource of the sidelink channel.

59. A second radio node, comprising:
a radio modem;
non-transitory computer readable media including machine readable instructions; and
a processor configured to load and to execute the machine readable instructions, the machine readable instructions being for transmitting a signal from the second radio node to a first radio and/or a third radio node via a sidelink channel in an unlicensed radio band of a radio access network, the machine readable instructions, when executed by the processor, causing the second radio node to perform the following steps:
receiving a signal transmitted from the first radio node to the second radio node via the sidelink channel in the unlicensed radio band during a channel occupancy time of the first radio node, wherein the received signal includes information regarding the channel occupancy time of the first radio node,
accessing the sidelink channel during the channel occupancy time of the first radio node, and
transmitting the signal from the second radio node to the first radio node and/or the third radio node via the sidelink channel,
wherein the signal is transmitted by sharing the channel occupancy time of the first radio node.

60. A system for radio communication, comprising:
a first radio node, including:
a radio modem;
non-transitory computer readable media including machine readable instructions; and
a processor configured to load and to execute the machine readable instructions, the machine readable instructions being transmitting a signal from the first radio node to a second radio node via a sidelink channel in an unlicensed radio band of a radio access network, the machine-readable instructions, when executed by the processor, causing the first radio node to perform the following steps:
performing channel sensing of the sidelink channel by decoding sidelink information of the sidelink channel during a sensing period, to identify at least one transmission resource of the sidelink channel for transmitting the signal to the second radio node,
performing channel contention of the sidelink channel using a listen-before-talk mechanism during a contention period preceding the at least one identified transmission resource, wherein the sensing period and the contention period overlap at least partially,
based on a positive result of the channel contention, accessing the sidelink channel for a duration of a channel occupancy time including the at least one identified transmission resource, and
transmitting the signal from the first radio node to the second radio node using the at least one identified transmission resource of the sidelink channel; and
a second radio node, including:
a second radio modem;
second non-transitory computer readable media including second machine readable instructions; and
a second processor configured to load and to execute the second machine readable instructions, the second machine readable instructions being for transmitting a signal from the second radio node to the first radio and/or a third radio node via the sidelink channel in the unlicensed radio band of the radio access network, the second machine readable instructions, when executed by the second processor, causing the second radio node to perform the following steps:
receiving a signal transmitted from the first radio node to the second radio node via the sidelink channel in the unlicensed radio band during the channel occupancy time of the first radio node, wherein the received signal includes information regarding the channel occupancy time of the first radio node,
accessing the sidelink channel during the channel occupancy time of the first radio node, and
transmitting the signal from the second radio node to the first radio node and/or the third radio node via the sidelink channel,
wherein the signal is transmitted by sharing the channel occupancy time of the first radio node.

61. A non-transitory computer readable medium on which are stored a computer program for transmitting a signal from a first radio node to a second radio node via a sidelink channel in an unlicensed radio band of a radio access network, the computer program, when executed by a processor, causing the processor to perform the following steps:
performing channel sensing of the sidelink channel by decoding sidelink information of the sidelink channel during a sensing period, to identify at least one transmission resource of the sidelink channel for transmitting the signal to the second radio node;
performing channel contention of the sidelink channel using a listen-before-talk mechanism during a contention period preceding the at least one identified transmission resource, wherein the sensing period and the contention period overlap at least partially;
based on a positive result of the channel contention, accessing the sidelink channel for a duration of a channel occupancy time including the at least one identified transmission resource; and
transmitting the signal from the first radio node to the second radio node using the at least one identified transmission resource of the sidelink channel.
